(19) United States
(12) Patent Application Publication
(10) Pub. No.: US 2026/0175596 A1
(43) Pub. Date: Jun. 25, 2026

(54) ULTRAVIOLET-CURED LIQUID EJECTING APPARATUS AND METHOD OF CONTROLLING ULTRAVIOLET-CURED LIQUID EJECTING APPARATUS

(71) Applicant: SEIKO EPSON CORPORATION, Tokyo (JP)

(72) Inventors: Masahiro TOTANI, Shiojiri (JP); Toru MATSUYAMA, Matsumoto (JP)

(21) Appl. No.: 19/430,393

(22) Filed: Dec. 23, 2025

(30) Foreign Application Priority Data
Dec. 25, 2024 (JP) 2024-228423

(51) Int. Cl. B41J 11/00

(52) U.S. Cl. CPC B41J 11/00212; B41J 11/00214; B41J 11/00218

(57) ABSTRACT

An ultraviolet-cured liquid ejecting apparatus includes an ejection head that ejects a liquid cured by being irradiated with an ultraviolet ray, an ultraviolet light source that includes a plurality of light emitting elements and that outputs the ultraviolet ray, an intensity adjustment mechanism that adjusts intensity of the ultraviolet ray, an irradiation level sensor that detects an irradiation level of the ultraviolet ray, and a relative position control mechanism that changes a relative position between the irradiation level sensor and the ultraviolet light source, in which the intensity adjustment mechanism adjusts the intensity of the ultraviolet ray based on the irradiation level of the ultraviolet ray detected by the irradiation level sensor during a period in which the relative position control mechanism changes the relative position between the irradiation level sensor and the ultraviolet light source.

The present application is based on, and claims priority from JP Application Serial Number 2024-228423, filed Dec. 25, 2024, the disclosure of which is hereby incorporated by reference herein in its entirety.

### BACKGROUND

### 1. Technical Field

The present disclosure relates to an ultraviolet-cured liquid ejecting apparatus and a method of controlling an ultraviolet-cured liquid ejecting apparatus.

### 2. Related Art

JP-A-2013-043310 discloses a liquid ejecting apparatus that ejects an ultraviolet-cured ink cured by being irradiated with an ultraviolet ray to a medium.

When a plurality of light emitting elements are used as a light source for the irradiation with the ultraviolet ray, the technology according to JP-A-2013-043310 is not sufficient from the viewpoint of appropriately controlling a light quantity of the ultraviolet ray with which the irradiation is performed, and there is room for improvement.

### SUMMARY

According to an aspect of the present disclosure, there is provided an ultraviolet-cured liquid ejecting apparatus including an ejection head that ejects a liquid cured by being irradiated with an ultraviolet ray, an ultraviolet light source that includes a plurality of light emitting elements and that outputs the ultraviolet ray, an intensity adjustment mechanism that adjusts intensity of the ultraviolet ray, an irradiation level sensor that detects an irradiation level of the ultraviolet ray, and a relative position control mechanism that changes a relative position between the irradiation level sensor and the ultraviolet light source, in which the intensity adjustment mechanism adjusts the intensity of the ultraviolet ray based on the irradiation level of the ultraviolet ray detected by the irradiation level sensor during a period in which the relative position control mechanism changes the relative position between the irradiation level sensor and the ultraviolet light source.

According to another aspect of the present disclosure, there is provided a method of controlling an ultraviolet-cured liquid ejecting apparatus that ejects a liquid cured by being irradiated with an ultraviolet ray, the method including a relative position control step of changing a relative position between an irradiation level sensor that detects an irradiation level of the ultraviolet ray, and an ultraviolet light source that includes a plurality of light emitting elements and that outputs the ultraviolet ray, a detection step of detecting the irradiation level of the ultraviolet ray in synchronization with the relative position control step, and an adjustment step of adjusting intensity of the ultraviolet ray based on the irradiation level of the ultraviolet ray detected in the detection step.

### BRIEF DESCRIPTION OF THE DRAWINGS

FIG. 1 is a diagram for describing a functional configuration of a liquid ejecting apparatus.

FIGS. 2A and 2B are diagrams showing a summary of an operation of forming an image on a medium.

FIG. 3 is a diagram for describing an example of a structure of an ultraviolet irradiation device.

FIG. 4 is a diagram showing an example of disposition of a carriage during a period in which an intensity adjustment process is executed.

FIG. 5 is a diagram showing an example of disposition of the carriage during the period in which the intensity adjustment process is executed.

FIG. 6 is a diagram for describing an irradiance distribution of an ultraviolet ray output by the ultraviolet irradiation device.

FIG. 7 is a diagram for describing a specific example of the intensity adjustment process.

### DESCRIPTION OF EMBODIMENTS

Hereinafter, preferred embodiments of the present disclosure will be described with reference to the drawings. The drawings are used for convenience of description. The embodiments described below do not unduly limit the contents of the present disclosure according to the claims. In addition, not all configurations described below are essential requirements of the present disclosure.

### 1. Summary of Liquid Ejecting Apparatus

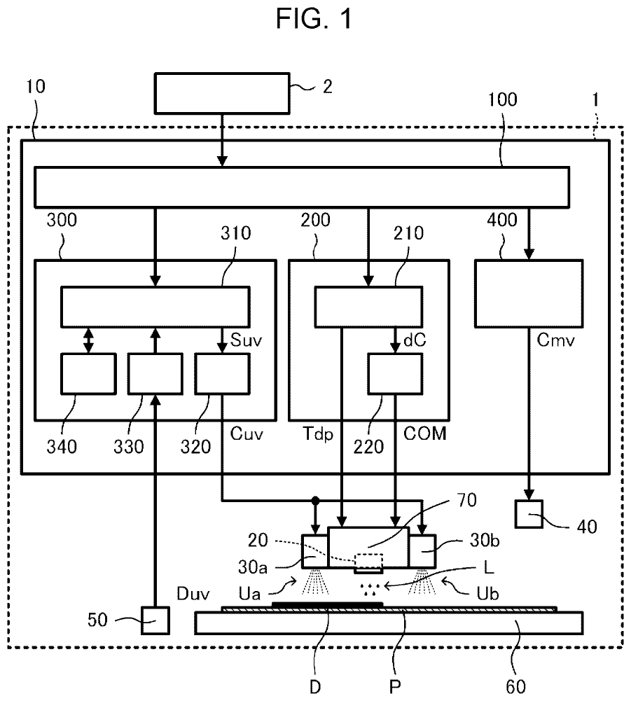

FIG. 1 is a diagram for describing a functional configuration of a liquid ejecting apparatus 1 of the present embodiment. As shown in FIG. 1, an image data signal defining printing specifications corresponding to an image D formed on a medium P is input into the liquid ejecting apparatus 1 from an external apparatus 2 such as a computer. The liquid ejecting apparatus 1 is a so-called ultraviolet-cured liquid ejecting apparatus that forms the image D on the medium P by ejecting, as an example of a liquid, an ink of an ultraviolet-cured type cured by an ultraviolet ray to the medium P in accordance with the input image data signal and irradiating a dot formed on the medium P by the ink with ultraviolet rays Ua and Ub to cure and fix the ink contained in the dot. The ultraviolet-cured liquid ejecting apparatus which is the liquid ejecting apparatus 1 may also be referred to as an ultraviolet (UV) printer.

The liquid ejecting apparatus 1 includes a control mechanism 10, a printhead 20, ultraviolet irradiation devices 30a and 30b, a moving mechanism 40, a detection mechanism 50, a platen 60, and a carriage 70.

The image data signal output by the external apparatus 2 is input into the control mechanism 10 included in the liquid ejecting apparatus 1. The control mechanism 10 includes a control unit 100, an ejection control unit 200, an irradiation control unit 300, and a moving control unit 400. The control mechanism 10 generates a signal for controlling each portion of the liquid ejecting apparatus 1 including the printhead 20, the ultraviolet irradiation devices 30a and 30b, and the moving mechanism 40 in accordance with the input image data signal and outputs the signal to the corresponding configurations.

The image data signal is input into the control unit 100 included in the control mechanism 10. The control unit 100 is configured to include a central processing unit (CPU), a field programmable gate array (FPGA), and the like. The control unit 100 generates various signals for controlling the ejection control unit 200, the irradiation control unit 300, and the moving control unit 400 by performing predetermined signal processing on the input image data signal and outputs the generated signals to the corresponding configurations.

The ejection control unit 200 includes an ejection control circuit 210 and a driving circuit 220. The signal output by the control unit 100 is input into the ejection control circuit 210. In accordance with the signal output by the control unit 100, the ejection control circuit 210 generates a base driving signal dC defining a signal waveform of a driving signal COM for driving a plurality of driving elements included in the printhead 20 to eject the ink from the printhead 20 and outputs the base driving signal dC to the driving circuit 220. The driving circuit 220 generates the driving signal COM having a high voltage that can drive the plurality of driving elements included in the printhead 20, by amplifying the signal waveform defined by the base driving signal dC and outputs the driving signal COM to the printhead 20.

In addition, in accordance with the signal output by the control unit 100, the ejection control circuit 210 generates a timing control signal Tdp for controlling a supply timing of the driving signal COM to each of the plurality of driving elements included in the printhead 20, that is, a signal for controlling an ejection timing and an ejection amount of the ink from the printhead 20, and outputs the timing control signal Tdp to the printhead 20.

The printhead 20 includes the above plurality of driving elements and a plurality of nozzles that correspond to each of the plurality of driving elements and from which the ink is ejected by driving the driving elements. The printhead 20 ejects a predetermined amount of an ink droplet L from each of the plurality of nozzles to the medium P by supplying the driving signal COM to the driving elements at the timing defined by the timing control signal Tdp. Examples of the driving elements included in the printhead 20 may include a piezoelectric element that is displaced by being supplied with the driving signal and that ejects the ink by the displacement, or a heating element that generates heat by being supplied with the driving signal and that ejects the ink by the heat generation.

The irradiation control unit 300 includes an irradiation control circuit 310, a light source driving circuit 320, a shaping circuit 330, and a storage circuit 340. The signal output by the control unit 100 is input into the irradiation control circuit 310. The irradiation control circuit 310 generates an intensity designation signal Suv defining a light quantity of the ultraviolet rays Ua and Ub output by the ultraviolet irradiation devices 30a and 30b, that is, intensity of the ultraviolet rays Ua and Ub output by the ultraviolet irradiation devices 30a and 30b, in accordance with light quantity adjustment information, described later, at the timing defined by the signal output by the control unit 100, and outputs the intensity designation signal Suv to the light source driving circuit 320. The light source driving circuit 320 generates a light source driving signal Cuv corresponding to the input intensity designation signal Suv and outputs the light source driving signal Cuv to each of the ultraviolet irradiation devices 30a and 30b.

In FIG. 1, the light source driving circuit 320 is illustrated as outputting one common light source driving signal Cuv to the ultraviolet irradiation devices 30a and 30b. However, the light source driving circuit 320 may output different light source driving signals Cuv to the ultraviolet irradiation device 30a and the ultraviolet irradiation device 30b. The light source driving signal Cuv output to the ultraviolet irradiation device 30a may be referred to as a light source driving signal Cuva, and the light source driving signal Cuv output to the ultraviolet irradiation device 30b may be referred to as a light source driving signal Cuvb. In the following description, the intensity of the ultraviolet rays Ua and Ub and the light quantity of the ultraviolet rays Ua and Ub are synonymous with each other and correspond to an energy level that can be supplied by the ultraviolet rays Ua and Ub.

Each of the ultraviolet irradiation devices 30a and 30b includes a plurality of light emitting elements LD, described later. For example, light emitting diodes (LEDs) that output light in an ultraviolet wavelength range are used as the light emitting elements LD. The ultraviolet irradiation devices 30a and 30b output the ultraviolet rays Ua and Ub, respectively, having intensity corresponding to the input light source driving signal Cuv by causing the plurality of light emitting elements LD to emit light with the intensity corresponding to the input light source driving signal Cuv. That is, the liquid ejecting apparatus 1 of the present embodiment includes the ultraviolet irradiation device 30a that outputs the ultraviolet ray Ua, and the ultraviolet irradiation device 30b that outputs the ultraviolet ray Ub.

The intensity of the ultraviolet rays Ua and Ub output by the ultraviolet irradiation devices 30a and 30b is an energy level that can be supplied to the ink droplet L which have landed on the medium P by the ultraviolet rays Ua and Ub, and may be, for example, ultraviolet irradiance that is an index showing a level of intensity of the ultraviolet ray with which a predetermined area is irradiated. That is, the intensity of the ultraviolet rays Ua and Ub output by the ultraviolet irradiation devices 30a and 30b includes the light quantity of the ultraviolet rays Ua and Ub output by the ultraviolet irradiation devices 30a and 30b. The light source driving circuit 320 may generate the light source driving signal Cuv having a current value defined by the intensity designation signal Suv and output the light source driving signal Cuv to each of the ultraviolet irradiation devices 30a and 30b. Accordingly, a light quantity of the light emitting elements LD included in each of the ultraviolet irradiation devices 30a and 30b, that is, the intensity of the ultraviolet rays Ua and Ub output by the ultraviolet irradiation devices 30a and 30b, is controlled.

For example, when it is desired to increase the intensity of the ultraviolet rays Ua and Ub output by the ultraviolet irradiation devices 30a and 30b, the light source driving circuit 320 increases a current level of the output light source driving signal Cuv. When it is desired to decrease the intensity of the ultraviolet rays Ua and Ub output by the ultraviolet irradiation devices 30a and 30b, the light source driving circuit 320 decreases the current level of the output light source driving signal Cuv. The light source driving circuit 320 may be configured to generate the light source driving signal Cuv having a current value and a voltage value corresponding to the intensity designation signal Suv and output the light source driving signal Cuv to each of the ultraviolet irradiation devices 30a and 30b.

The ultraviolet irradiation devices 30a and 30b have the same configuration. Thus, in the following description, the ultraviolet irradiation device 30a and the ultraviolet irradiation device 30b may be simply referred to as an ultraviolet irradiation device 30 unless necessary to distinguish therebetween. In the description, the ultraviolet irradiation device 30 receives input of the light source driving signal Cuv and outputs an ultraviolet ray U as the ultraviolet rays Ua and Ub. Details of the ultraviolet irradiation device 30 will be described later.

The shaping circuit 330 receives input of an ultraviolet detection signal Duv output by the detection mechanism 50. The detection mechanism 50 may be configured to include a photodiode or the like that can detect a light quantity corresponding to the ultraviolet wavelength range and output an electrical signal corresponding to the detected light quantity. The detection mechanism 50 detects a light quantity of the ultraviolet ray U output by the ultraviolet irradiation device 30 at a predetermined timing and outputs the ultraviolet detection signal Duv corresponding to the detected light quantity of the ultraviolet ray U. That is, the detection mechanism 50 generates the ultraviolet detection signal Duv having a voltage value corresponding to the ultraviolet irradiance of the ultraviolet ray U, that is, the intensity or light quantity of the ultraviolet ray U, and outputs the ultraviolet detection signal Duv to the shaping circuit 330.

The shaping circuit 330 shapes a signal waveform of the ultraviolet detection signal Duv by removing a noise component from the ultraviolet detection signal Duv input from the detection mechanism 50 and amplifying the ultraviolet detection signal Duv, and outputs the ultraviolet detection signal Duv to the irradiation control circuit 310. The shaping circuit 330 can be configured to include, for example, a filter circuit that removes noise, and an amplification circuit that amplifies a signal from which noise is removed by the filter circuit. In addition to or instead of the filter circuit and the amplification circuit described above, the shaping circuit 330 may be configured to include a voltage follower circuit that converts impedance of a signal corresponding to the ultraviolet detection signal Duv, an A/D conversion circuit that converts the signal corresponding to the ultraviolet detection signal Duv into a digital signal, and the like.

The irradiation control circuit 310 acquires the intensity of the ultraviolet ray U output by the ultraviolet irradiation device 30 from the signal corresponding to the ultraviolet detection signal Duv input from the shaping circuit 330. The irradiation control circuit 310 adjusts the intensity designation signal Suv defining the intensity of the ultraviolet rays Ua and Ub such that a value of the signal corresponding to the ultraviolet detection signal Duv input from the shaping circuit 330 reaches a predetermined value. Accordingly, the current level of the light source driving signal Cuv output by the light source driving circuit 320 is adjusted, and thus, the intensity of the ultraviolet rays Ua and Ub output by each of the ultraviolet irradiation devices 30a and 30b is adjusted. That is, the energy level supplied to the ink droplet L which has landed on the medium P is adjusted. The irradiation control circuit 310 stores, in the storage circuit 340, a value of the intensity designation signal Suv after being adjusted such that the value of the signal corresponding to the ultraviolet detection signal Duv input from the shaping circuit 330 reaches the predetermined value, as the light quantity adjustment information. Details of a method of adjusting the intensity of the ultraviolet rays Ua and Ub output by each of the ultraviolet irradiation devices 30a and 30b will be described later.

The storage circuit 340 is a non-volatile memory. For example, an EEPROM or a flash memory can be used as the storage circuit 340. In addition to the above light quantity adjustment information, the storage circuit 340 may store various types of information related to operations of the irradiation control unit 300 and the ultraviolet irradiation devices 30a and 30b. The light quantity adjustment information stored in the storage circuit 340 may only need to be information used for adjusting the intensity of the ultraviolet rays Ua and Ub. For example, the light quantity adjustment information may be information on the current level of the light source driving signal Cuv after being adjusted such that the value of the signal corresponding to the ultraviolet detection signal Duv input from the shaping circuit 330 reaches the predetermined value, an initial setting value of the intensity designation signal Suv and an adjustment value obtained by adjusting the intensity designation signal Suv when the value of the signal corresponding to the ultraviolet detection signal Duv input from the shaping circuit 330 reaches the predetermined value, or an initial setting value of the light source driving signal Cuv and an adjustment value obtained by adjusting the light source driving signal Cuv when the value of the signal corresponding to the ultraviolet detection signal Duv input from the shaping circuit 330 reaches the predetermined value.

As described above, by acquiring the current intensity of the ultraviolet ray U output by the ultraviolet irradiation device 30 and adjusting the intensity of the ultraviolet ray U output by the ultraviolet irradiation device 30 to predetermined intensity, the irradiation control unit 300 controls the intensity of the ultraviolet ray U output by the ultraviolet irradiation device 30 to be substantially constant.

The signal output by the control unit 100 is input into the moving control unit 400. The moving control unit 400 generates a moving control signal Cmv for controlling movement of the medium P along a transport direction and reciprocation of the carriage 70 along a scanning axis and outputs the moving control signal Cmv to the moving mechanism 40.

The moving mechanism 40 includes a transport motor and a transport roller that move the medium P. The transport motor is rotationally driven in accordance with the moving control signal Cmv, and the transport roller rotates in accordance with the rotational driving of the transport motor in a state where the medium P is supported or pinched. By rotating the transport roller, the medium P moves along the transport direction. The medium P is supported by the platen 60. That is, by driving the transport motor, the medium P moves along the transport direction in a state of being supported by the platen 60.

The moving mechanism 40 includes a carriage motor and an endless belt that move the carriage 70. The carriage motor is rotationally driven in accordance with the moving control signal Cmv. A part of the carriage 70 is fixed to the endless belt. By rotating the endless belt in accordance with the rotational driving of the carriage motor, the carriage 70 moves in accordance with the rotation of the endless belt. A moving direction of the carriage 70 along the scanning axis is switched by switching a rotation direction of the carriage motor between forward rotation and reverse rotation in accordance with the moving control signal Cmv. Accordingly, the carriage 70 reciprocates along the scanning axis.

The printhead 20 and the ultraviolet irradiation devices 30a and 30b are mounted on the carriage 70. The ultraviolet irradiation device 30a is positioned at one end portion of the carriage 70 along the scanning axis, and the ultraviolet irradiation device 30b is positioned at the other end portion of the carriage 70 along the scanning axis. The printhead 20 is positioned between the ultraviolet irradiation device 30a and the ultraviolet irradiation device 30b along the scanning axis. By causing the carriage 70 to reciprocate along the scanning axis in accordance with the moving control signal Cmv, the printhead 20 and the ultraviolet irradiation devices 30a and 30b mounted on the carriage 70 also reciprocate along the scanning axis.

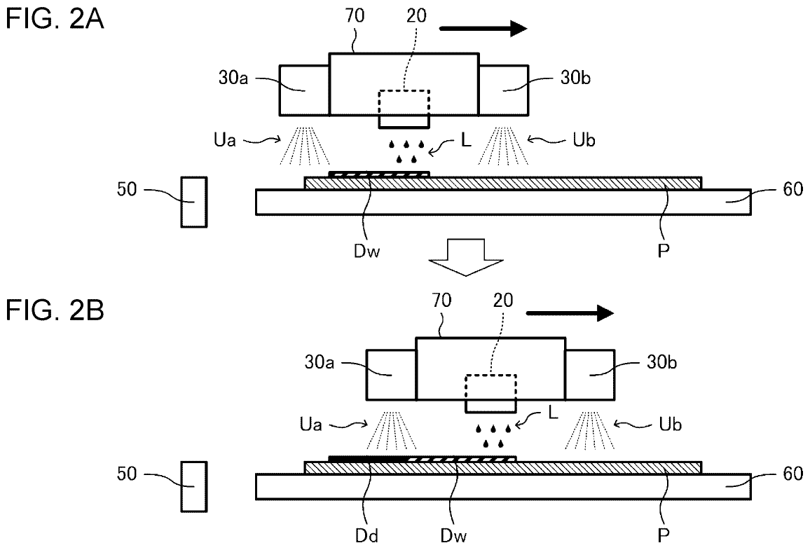

An example of an operation when the liquid ejecting apparatus 1 configured as described above forms the image D on the medium P will be described. FIGS. 2A and 2B are diagrams showing a summary of the operation of forming the image D on the medium P via the liquid ejecting apparatus 1 according to the present embodiment. In the description, the carriage 70 on which the printhead 20 is mounted is assumed to move in a direction along the arrow in FIGS. 2A and 2B. FIG. 2A illustrates a state where the ink droplet L is ejected from the printhead 20, and a dot Dw before being cured is formed on the medium P. FIG. 2B illustrates a state where the ink contained in the dot Dw is cured and fixed to form a dot Dd on the medium P by irradiating the dot Dw after being formed on the medium P with the ultraviolet ray Ua.

As shown in FIG. 2A, the medium P moves to a predetermined position of the platen 60 under control of the moving mechanism 40. The carriage 70 on which the printhead 20 and the ultraviolet irradiation devices 30a and 30b are mounted moves in the direction of the illustrated arrow along the scanning axis under control of the moving mechanism 40. The ink droplet L is ejected from the printhead 20 in synchronization with the movement of the carriage 70 under control of the ejection control unit 200. The dot Dw is formed on the medium P by causing the ink droplet L ejected from the printhead 20 to land on the medium P.

Then, as shown in FIG. 2B, the carriage 70 continues moving along the arrow. Accordingly, the dot Dw is irradiated with the ultraviolet ray Ua output by the ultraviolet irradiation device 30a positioned behind the printhead 20 in the moving direction of the carriage 70. Accordingly, polymerization of the ink of the ultraviolet-cured type included in the dot Dw starts and proceeds. Thus, the ink of the ultraviolet-cured type is cured and fixed on the medium P to form the dot Dd on the medium P.

While illustration is not provided, even when the carriage 70 moves in a direction opposite to the arrow shown in FIGS. 2A and 2B, the dot Dd is formed on the medium P by the same operation.

That is, after the medium P is moved to the predetermined position of the platen 60 under control of the moving mechanism 40, the carriage 70 on which the printhead 20 and the ultraviolet irradiation devices 30a and 30b are mounted moves in the direction opposite to the illustrated arrow along the scanning axis under control of the moving mechanism 40. The ink droplet L is ejected from the printhead 20 in synchronization with the movement of the carriage 70 under the control of the ejection control unit 200, and the dot Dw is formed on the medium P. Then, by causing the carriage 70 to continue moving along the direction opposite to the illustrated arrow, the dot Dw is irradiated with the ultraviolet ray Ub output by the ultraviolet irradiation device 30b positioned behind the printhead 20 in the moving direction. Accordingly, the polymerization of the ink of the ultraviolet-cured type included in the dot Dw starts and proceeds, and the dot Dd is formed on the medium P.

In the liquid ejecting apparatus 1 of the present embodiment, the dot Dd is sequentially formed at a desired position of the medium P by repeatedly executing the transport of the medium P along the transport direction, the ejection of the ink droplet L from the printhead 20, and the curing and fixing of the ink. Thus, the image D corresponding to the image data signal is formed on the medium P.

That is, in the liquid ejecting apparatus 1 of the present embodiment, under control of the control unit 100 in accordance with the image data signal, the moving control unit 400 controls the reciprocation of the carriage 70 along the scanning axis and the transport of the medium P along the transport direction, and the ejection control unit 200 ejects the ink droplet L from the printhead 20 at a timing synchronized with the reciprocation of the carriage 70 along the scanning axis and the transport of the medium P along the transport direction. Accordingly, the ink droplet L lands at the desired position of the medium P, and the dot Dw is formed at the desired position of the medium P. Then, the ink contained in the dot Dw is cured and fixed to form the dot Dd on the medium P by causing the ultraviolet irradiation devices 30a and 30b to irradiate the dot Dw with the ultraviolet rays Ua and Ub via the irradiation control unit 300 under control of the control unit 100. In the liquid ejecting apparatus 1 of the present embodiment, the desired image D is formed on the medium P by repeatedly executing the ejection of the ink and the curing and fixing of the ejected ink.

In other words, the liquid ejecting apparatus 1 of the present embodiment includes the printhead 20 that ejects the ink of the ultraviolet-cured type cured by being irradiated with the ultraviolet ray U, the ultraviolet irradiation device 30 that includes the plurality of light emitting elements LD and that outputs the ultraviolet ray U, the irradiation control circuit 310 that adjusts the intensity of the ultraviolet ray U, the detection mechanism 50 that detects an irradiation level of the ultraviolet ray U, that is, the intensity or the light quantity of the ultraviolet ray U, and the moving mechanism 40 that changes a relative position between the detection mechanism 50 and the ultraviolet irradiation device 30 by moving the carriage 70 on which the ultraviolet irradiation device 30 is mounted.

When the carriage 70 is moving in the direction along the arrow shown in FIGS. 2A and 2B, and the ink contained in the dot Dw formed on the medium P is cured and fixed by the ultraviolet ray Ua, the ultraviolet irradiation device 30b may stop outputting the ultraviolet ray Ub. When the carriage 70 is moving in the direction opposite to the arrow shown in FIGS. 2A and 2B, and the ink contained in the dot Dw formed on the medium P is cured and fixed by the ultraviolet ray Ub, the ultraviolet irradiation device 30a may stop outputting the ultraviolet ray Ua.

### 2. Intensity Adjustment of Ultraviolet Ray

As described above, in the liquid ejecting apparatus 1 of the present embodiment, the ink contained in the dot Dw is cured and fixed to form the dot Dd on the medium P by irradiating the dot Dw formed on the medium P by the ink of the ultraviolet-cured type with the ultraviolet ray U via the ultraviolet irradiation device 30. In the liquid ejecting apparatus 1, when an energy level of the ultraviolet ray U with which the ink contained in the dot Dw is irradiated is excessive or insufficient, there is a probability of variation in degrees of the curing and fixing of the ink, resulting in a decrease in quality of the image formed on the medium P. In the liquid ejecting apparatus 1 of the present embodiment, the irradiation control unit 300 executes an intensity adjustment process of adjusting the intensity of the ultraviolet ray U output by the ultraviolet irradiation device 30 to be substantially constant. Accordingly, the energy level supplied to the dot Dw by the irradiation with the ultraviolet ray U, that is, the intensity or the light quantity of the ultraviolet ray U with which the ink contained in the dot Dw is irradiated, can be controlled to be substantially constant. Thus, a probability of excess or insufficiency of the energy level of the ultraviolet ray U with which the ink contained in the dot Dw is irradiated is reduced.

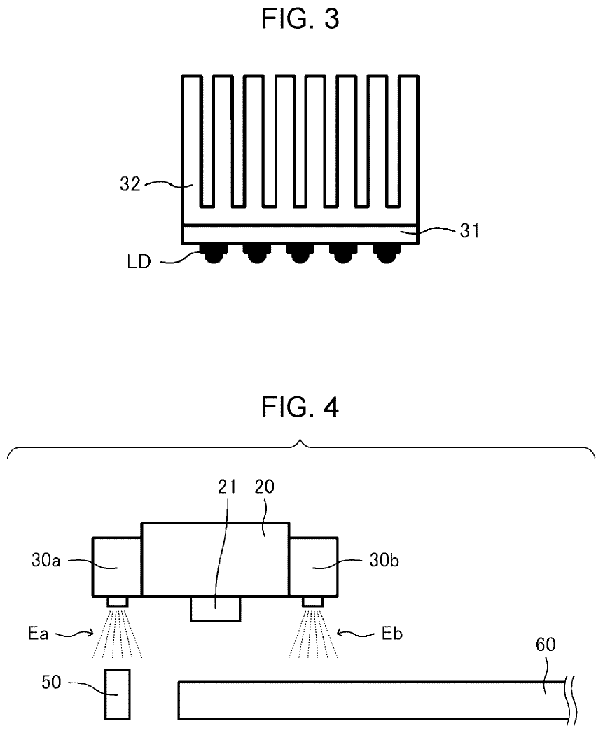

In describing details of the intensity adjustment process of adjusting the intensity of the ultraviolet ray U output by the ultraviolet irradiation device 30 to be substantially constant, an example of a structure of the ultraviolet irradiation device 30 that outputs the ultraviolet ray U will be described first. FIG. 3 is a diagram for describing the example of the structure of the ultraviolet irradiation device 30. As shown in FIG. 3, the ultraviolet irradiation device 30 includes a base member 31, the plurality of light emitting elements LD, and a heat sink 32.

The base member 31 is a wiring substrate in which a plurality of wiring patterns are formed, and the plurality of light emitting elements LD are mounted in a matrix on one surface of the base member 31. The light source driving signal Cuv input into the ultraviolet irradiation device 30 propagates through the wiring patterns formed in the base member 31 and is supplied to the plurality of light emitting elements LD. Accordingly, each of the plurality of light emitting elements LD emits light in accordance with the light source driving signal Cuv, and by emitting light via the plurality of light emitting elements LD, the ultraviolet ray U is output from the ultraviolet irradiation device 30.

The heat sink 32 is attached to the other surface of the base member 31. In the ultraviolet irradiation device 30, the plurality of light emitting elements LD are disposed at high density on one surface of the base member 31. Accordingly, a range of the intensity of the ultraviolet ray U that can be output by the ultraviolet irradiation device 30 can be expanded, and versatility of the ultraviolet irradiation device 30 can be increased. Meanwhile, since the plurality of light emitting elements LD are disposed at high density on one surface of the base member 31, a quantity of heat generated by the plurality of light emitting elements LD is increased, and a temperature of the plurality of light emitting elements LD rises. The rise in the temperature of the plurality of light emitting elements LD contributes to characteristics of the light output by the light emitting elements LD. By thermally coupling the heat sink 32 to the plurality of light emitting elements LD via the base member 31, the heat generated by the plurality of light emitting elements LD can be efficiently dissipated. Accordingly, in the ultraviolet irradiation device 30, even when the plurality of light emitting elements LD are disposed at high density, a probability of a change in characteristics of the light emitting elements LD is reduced, and a probability of a change in characteristics of the ultraviolet ray U output by the ultraviolet irradiation device 30 is also reduced.

That is, the ultraviolet irradiation device 30a outputs the ultraviolet ray Ua by including the plurality of light emitting elements LD and emitting light via the plurality of light emitting elements LD, and the ultraviolet irradiation device 30b outputs the ultraviolet ray Ub by including the plurality of light emitting elements LD and emitting light via the plurality of light emitting elements LD.

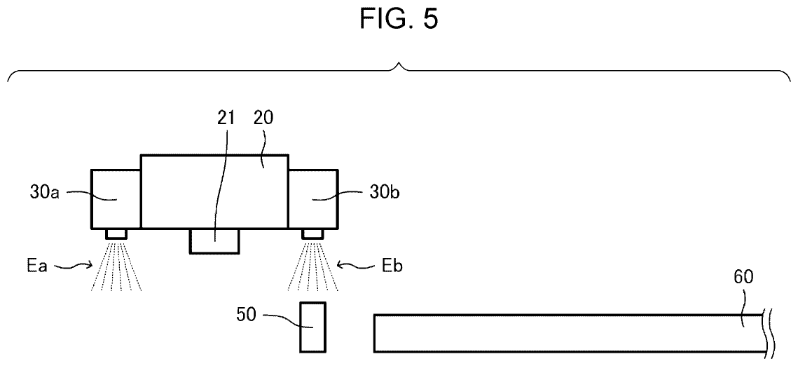

Next, disposition of the carriage 70 on which the printhead 20 and the ultraviolet irradiation devices 30a and 30b are mounted during a period in which the intensity adjustment process is executed will be described. FIGS. 4 and 5 are diagrams showing an example of the disposition of the carriage 70 during the period in which the intensity adjustment process is executed. FIG. 4 illustrates an example of the disposition of the carriage 70 when the intensity adjustment process is executed on the ultraviolet ray Ua output by the ultraviolet irradiation device 30a, and FIG. 5 illustrates an example of the disposition of the carriage 70 when the intensity adjustment process is executed on the ultraviolet ray Ub output by the ultraviolet irradiation device 30b.

As shown in FIGS. 4 and 5, the detection mechanism 50 that outputs the ultraviolet detection signal Duv corresponding to the light quantity of the ultraviolet rays Ua and Ub, that is, the intensity of the ultraviolet rays Ua and Ub, is positioned in a region separated from a transport region in which the medium P is transported. In FIGS. 4 and 5, the detection mechanism 50 is illustrated as being configured as a separate body separated from the platen 60. However, the detection mechanism 50 may be configured to be integrated with the platen 60.

When the intensity adjustment process of adjusting the intensity of the ultraviolet ray Ua is executed, the moving mechanism 40, as shown in FIG. 4, moves the carriage 70 in accordance with the moving control signal Cmv output by the moving control unit 400 such that the ultraviolet irradiation device 30a reaches a position facing the detection mechanism 50. Accordingly, the detection mechanism 50 detects the light quantity of the ultraviolet ray Ua output by the ultraviolet irradiation device 30a.

Similarly, when the intensity adjustment process of adjusting the intensity of the ultraviolet ray Ub is executed, the moving mechanism 40, as shown in FIG. 5, moves the carriage 70 in accordance with the moving control signal Cmv output by the moving control unit 400 such that the ultraviolet irradiation device 30b reaches a position facing the detection mechanism 50. Accordingly, the detection mechanism 50 detects the light quantity of the ultraviolet ray Ub output by the ultraviolet irradiation device 30b.

The ultraviolet irradiation device 30b may stop outputting the ultraviolet ray Ub during a period in which the detection mechanism 50 detects the light quantity of the ultraviolet ray Ua, that is, the intensity of the ultraviolet ray Ua output by the ultraviolet irradiation device 30a. The ultraviolet irradiation device 30a may stop outputting the ultraviolet ray Ua during a period in which the detection mechanism 50 detects the light quantity of the ultraviolet ray Ub, that is, the intensity of the ultraviolet ray Ub output by the ultraviolet irradiation device 30b.

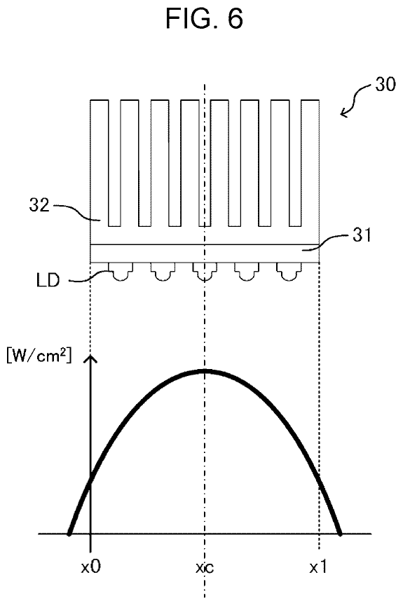

An irradiance distribution of the ultraviolet ray U output by the ultraviolet irradiation device 30, that is, a distribution of the light quantity of the ultraviolet ray U output by the ultraviolet irradiation device 30, will be described. FIG. 6 is a diagram for describing the irradiance distribution of the ultraviolet ray U output by the ultraviolet irradiation device 30. In FIG. 6, the structure of the ultraviolet irradiation device 30 is shown in addition to the irradiance distribution of the ultraviolet ray U output by the ultraviolet irradiation device 30.

As shown in FIG. 6, the irradiance of the ultraviolet ray U output by the ultraviolet irradiation device 30, that is, the light quantity of the ultraviolet ray U output by the ultraviolet irradiation device 30, is substantially at its maximum in a center portion xc substantially at the center of the ultraviolet irradiation device 30 and decreases toward an end portion x0 and an end portion x1 that are both ends of the ultraviolet irradiation device 30. That is, the irradiance of the ultraviolet ray U output by the ultraviolet irradiation device 30 changes even in a region facing the ultraviolet irradiation device 30 when a detection position slightly shifts in the region. Therefore, as shown in FIGS. 4 and 5, even when the detection mechanism 50 detects the light quantity of the ultraviolet ray Ua output by the ultraviolet irradiation device 30 in a state where the detection mechanism 50 is positioned to face the ultraviolet irradiation device 30, the light quantity of the ultraviolet ray U detected by the detection mechanism 50 varies because of a slight shift in the relative position between the ultraviolet irradiation device 30 and the detection mechanism 50. In a state where the light quantity detected by the detection mechanism 50 varies, when the intensity adjustment process of adjusting the light quantity, that is the intensity, of the ultraviolet ray U output by the ultraviolet irradiation device 30 is executed, the light quantity of the ultraviolet ray U output by the ultraviolet irradiation device 30 varies even after executing the intensity adjustment process. Thus, there is a probability of a decrease in the quality of the image formed on the medium P.

In view of such an issue, for example, by increasing control accuracy of a scanning position of the carriage 70 in the moving mechanism 40, a probability of a shift in the relative position between the ultraviolet irradiation device 30 and the detection mechanism 50 can be reduced, and a probability of variation in the light quantity of the ultraviolet ray U detected by the detection mechanism 50 can also be reduced. However, as shown in the liquid ejecting apparatus 1 of the present embodiment, when the ultraviolet irradiation device 30 is configured to output composite light of the plurality of light emitting elements LD as the ultraviolet ray U, the irradiance distribution of the ultraviolet ray U output by the ultraviolet irradiation device 30 changes when there is a slight shift in an optical axis of each of the plurality of light emitting elements LD caused by variation in mounting the plurality of light emitting elements LD mounted on the base member 31, or because of variation in the light quantity of each of the plurality of light emitting elements LD caused by variation in the characteristics of each of the plurality of light emitting elements LD.

In particular, such an issue is more remarkable when light emitting diodes having high directivity are used as the plurality of light emitting elements LD. Therefore, even when the probability of a shift in the relative position between the ultraviolet irradiation device 30 and the detection mechanism 50 is reduced by increasing the control accuracy of the scanning position of the carriage 70 in the moving mechanism 40, it is difficult to sufficiently reduce the variation in the light quantity detected by the detection mechanism 50. Therefore, there is a probability of variation in the light quantity, that is the intensity, of the ultraviolet ray U output by the ultraviolet irradiation device 30, even after executing the intensity adjustment process.

In view of such an issue, the liquid ejecting apparatus 1 of the present embodiment has a characteristic configuration of changing the relative position between the ultraviolet irradiation device 30 and the detection mechanism 50 during a period in which the intensity adjustment process of adjusting the intensity of the ultraviolet ray U output by the ultraviolet irradiation device 30 to be substantially constant is executed, and adjusting a light quantity of the ultraviolet irradiation device 30 based on the light quantity, that is, the intensity, of the ultraviolet ray U detected by the detection mechanism 50 during a period in which the relative position between the ultraviolet irradiation device 30 and the detection mechanism 50 is changed. A specific example of the intensity adjustment process will be described.

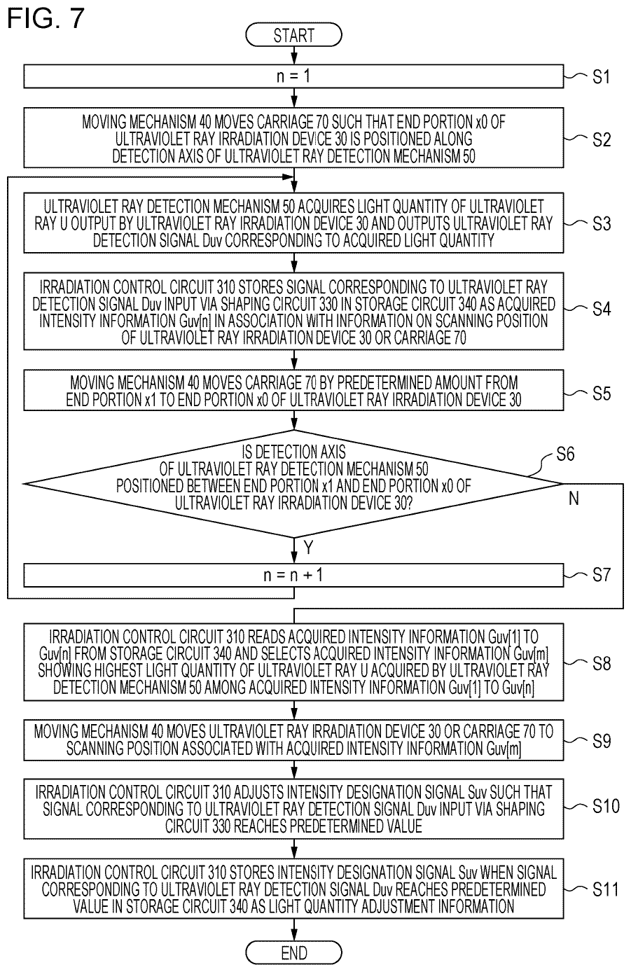

FIG. 7 is a diagram for describing the specific example of the intensity adjustment process in the liquid ejecting apparatus 1 of the present embodiment. In the following description, the ultraviolet irradiation device 30 is mounted on the carriage 70 such that the end portion x0 and the end portion x1 described above are positioned along the scanning axis.

When the intensity adjustment process is executed, the irradiation control circuit 310 executes initial setting of setting a variable n to “1” (step S1). After the initial setting is completed, the moving mechanism 40 moves the carriage 70 such that the end portion x0 of the ultraviolet irradiation device 30 is positioned along a detection axis of the detection mechanism 50 (step S2). The detection mechanism 50 acquires the light quantity of the ultraviolet ray U output by the ultraviolet irradiation device 30 and outputs the ultraviolet detection signal Duv corresponding to the acquired light quantity to the shaping circuit 330 (step S3). The ultraviolet detection signal Duv output by the detection mechanism 50 is input into the irradiation control circuit 310 after the signal waveform thereof is shaped by the shaping circuit 330. The irradiation control circuit 310 stores the signal corresponding to the ultraviolet detection signal Duv input via the shaping circuit 330 in the storage circuit 340 as acquired intensity information Guv[n] in association with information on the scanning position of the ultraviolet irradiation device 30 or the carriage 70 along the scanning axis when the ultraviolet detection signal Duv is acquired (step S4). Then, the moving mechanism 40 moves the carriage 70 by a predetermined amount in a direction of the end portion x0 from the end portion x1 of the ultraviolet irradiation device 30 along the scanning axis (step S5). The “predetermined amount” may be a distance sufficiently shorter than a distance between the end portion x0 and the end portion x1 in a direction along the scanning axis and, for example, may be defined based on a signal output by an encoder (not illustrated) that detects the scanning position of the carriage 70 in the direction along the scanning axis, or defined based on a rotation angle of the carriage motor that controls the movement of the carriage 70.

After the carriage 70 is moved by the predetermined amount in the direction of the end portion x0 from the end portion x1 of the ultraviolet irradiation device 30 along the scanning axis, the control unit 100 or the irradiation control circuit 310 determines whether or not the detection axis of the detection mechanism 50 is positioned between the end portion x0 and the end portion x1 of the ultraviolet irradiation device 30 (step S6). When the control unit 100 or the irradiation control circuit 310 determines that the detection axis of the detection mechanism 50 is positioned between the end portion x0 and the end portion x1 of the ultraviolet irradiation device 30 (Y in step S6), the irradiation control circuit 310 adds “1” to the variable n (step S7) and executes above steps S3 to S6 again. That is, the irradiation control circuit 310 moves the carriage 70 by the predetermined amount at a time during a period in which the detection axis of the detection mechanism 50 is positioned between the end portion x0 and the end portion x1 of the ultraviolet irradiation device 30, and each time the carriage 70 moves, acquires the signal corresponding to the ultraviolet detection signal Duv input via the shaping circuit 330 and stores the acquired signal corresponding to the ultraviolet detection signal Duv in the storage circuit 340 in association with positional information of the ultraviolet irradiation device 30 or the carriage 70 along the scanning axis when the signal corresponding to the ultraviolet detection signal Duv is acquired.

When the control unit 100 or the irradiation control circuit 310 determines that the detection axis of the detection mechanism 50 is not positioned between the end portion x0 and the end portion x1 of the ultraviolet irradiation device 30 (N in step S6), the irradiation control circuit 310 reads the acquired intensity information Guv[1] to Guv[n] from the storage circuit 340 and selects the acquired intensity information Guv[m] showing the maximum light quantity of the ultraviolet ray U detected by the detection mechanism 50 among the read acquired intensity information Guv[1] to Guv[n] (step S8). The moving mechanism 40 moves the ultraviolet irradiation device 30 or the carriage 70 to the scanning position associated with the acquired intensity information Guv[m] (step S9). Then, when the ultraviolet irradiation device 30 or the carriage 70 reaches the scanning position associated with the acquired intensity information Guv[m], the irradiation control circuit 310 adjusts the intensity designation signal Suv such that the signal corresponding to the ultraviolet detection signal Duv input via the shaping circuit 330 reaches the predetermined value (step S10). Accordingly, the maximum value of the intensity of the ultraviolet ray U, that is, the maximum light quantity of the ultraviolet ray U, output by the ultraviolet irradiation device 30 is adjusted to the predetermined value. That is, the irradiation control circuit 310 adjusts the intensity of the ultraviolet ray U such that the maximum value of the irradiation level of the ultraviolet ray U, that is, the intensity or the light quantity of the ultraviolet ray U, detected by the detection mechanism 50 reaches the predetermined value during a period in which the moving mechanism 40 changes the relative position between the detection mechanism 50 and the ultraviolet irradiation device 30.

The irradiation control circuit 310 stores the intensity designation signal Suv when the signal corresponding to the ultraviolet detection signal Duv input via the shaping circuit 330 reaches the predetermined value, in the storage circuit 340 as the light quantity adjustment information (step S11).

As described above, in the liquid ejecting apparatus 1 of the present embodiment, the irradiation control circuit 310 adjusts the light quantity, that is, the intensity, of the ultraviolet ray U based on the irradiation level of the ultraviolet ray U, that is, the intensity or the light quantity of the ultraviolet ray U, detected by the detection mechanism 50 during the period in which the moving mechanism 40 changes the relative position between the detection mechanism 50 and the ultraviolet irradiation device 30. That is, the intensity adjustment process of adjusting the intensity of the ultraviolet ray U output by the ultraviolet irradiation device 30 to be substantially constant, that is, a method of controlling the liquid ejecting apparatus 1 that ejects the ink cured by being irradiated with the ultraviolet ray U as shown in the present embodiment, includes steps S2 and S5 in which the moving mechanism 40 changes the relative position between the detection mechanism 50 that detects the irradiation level of the ultraviolet ray U, and the ultraviolet irradiation device 30 that includes the plurality of light emitting elements LD and that outputs the ultraviolet ray U, step S3 in which the detection mechanism 50 detects the irradiation level of the ultraviolet ray U in synchronization with the change in the relative position between the detection mechanism 50 that detects the irradiation level of the ultraviolet ray U, and the ultraviolet irradiation device 30 that includes the plurality of light emitting elements LD and that outputs the ultraviolet ray U, by the moving mechanism 40 in steps S2 and S5, and step S10 in which the intensity of the ultraviolet ray U is adjusted based on the irradiation level of the ultraviolet ray U detected by the detection mechanism 50 in step S3. In step S10, the irradiation control circuit 310 adjusts the intensity of the ultraviolet ray U such that the maximum value of the irradiation level of the ultraviolet ray U detected in step S3 reaches the predetermined value.

The liquid ejecting apparatus 1 of the present embodiment includes the ultraviolet irradiation device 30a and the ultraviolet irradiation device 30b as the ultraviolet irradiation device 30. Therefore, the intensity adjustment process in the liquid ejecting apparatus 1 of the present embodiment is individually executed for each of the ultraviolet irradiation device 30a and the ultraviolet irradiation device 30b. That is, the irradiation control circuit 310 adjusts the intensity of the ultraviolet ray Ua in accordance with the irradiation level of the ultraviolet ray Ua detected by the detection mechanism 50 during a period in which the moving mechanism 40 changes the relative position between the detection mechanism 50 and the ultraviolet irradiation device 30a, and adjusts the intensity of the ultraviolet ray Ub in accordance with the irradiation level of the ultraviolet ray Ub detected by the detection mechanism 50 during a period in which the moving mechanism 40 changes the relative position between the detection mechanism 50 and the ultraviolet irradiation device 30b. That is, step S3, shown in FIG. 7, in which the detection mechanism 50 detects the irradiation level of the ultraviolet ray U in synchronization with the change in the relative position with respect to the ultraviolet irradiation device 30 that includes the plurality of light emitting elements LD and that outputs the ultraviolet ray U includes a step of detecting the irradiation level of the ultraviolet ray Ua and a step of detecting the irradiation level of the ultraviolet ray Ub. Step S10 in which the intensity of the ultraviolet ray U is adjusted based on the irradiation level of the ultraviolet ray U detected by the detection mechanism 50 includes, as step S3, a step of adjusting the intensity of the ultraviolet ray Ua based on the irradiation level of the ultraviolet ray Ua detected in the step of detecting the irradiation level of the ultraviolet ray Ua and, as step S3, a step of adjusting the intensity of the ultraviolet ray Ub based on the irradiation level of the ultraviolet ray Ub detected in the step of detecting the irradiation level of the ultraviolet ray Ub.

The liquid ejecting apparatus 1 that ejects the ink of the ultraviolet-cured type cured by the ultraviolet ray corresponds to an ultraviolet-cured liquid ejecting apparatus, and the method of controlling the liquid ejecting apparatus 1 that ejects the ink of the ultraviolet-cured type cured by the ultraviolet ray, including the above method of the intensity adjustment process, corresponds to a method of controlling an ultraviolet-cured liquid ejecting apparatus. The printhead 20 is an example of an ejection head. The ultraviolet irradiation device 30 is an example of an ultraviolet light source. The moving mechanism 40 is an example of a relative position control mechanism. The detection mechanism 50 is an example of an irradiation level sensor. The irradiation control circuit 310 is an example of an intensity adjustment mechanism. The ultraviolet irradiation device 30a as the ultraviolet irradiation device 30 is an example of a first ultraviolet light source. The plurality of light emitting elements LD included in the ultraviolet irradiation device 30a are an example of a plurality of first light emitting elements. The ultraviolet ray Ua output by the ultraviolet irradiation device 30a is an example of a first ultraviolet ray. The ultraviolet irradiation device 30b as the ultraviolet irradiation device 30 is an example of a second ultraviolet light source. The plurality of light emitting elements LD included in the ultraviolet irradiation device 30b are an example of a plurality of second light emitting elements. The ultraviolet ray Ub output by the ultraviolet irradiation device 30b is an example of a second ultraviolet ray. Steps S2 and S5 in the intensity adjustment process are examples of a relative position control step. Step S3 is an example of a detection step. Step S10 is an example of an adjustment step. Step S3 executed on the ultraviolet irradiation device 30a is an example of a first detection step. Step S3 executed on the ultraviolet irradiation device 30b is an example of a second detection step. Step S10 executed on the ultraviolet irradiation device 30a is an example of a first adjustment step. Step S10 executed on the ultraviolet irradiation device 30b is an example of a second adjustment step.

### 3. Action and Effect

In the liquid ejecting apparatus 1 of the present embodiment configured as described above, the irradiation control circuit 310 that adjusts the light quantity, that is, the intensity, of the ultraviolet ray U adjusts the light quantity, that is, the intensity, of the ultraviolet ray U based on the irradiation level of the ultraviolet ray U, that is, the intensity or the light quantity of the ultraviolet ray U, detected by the detection mechanism 50 during the period in which the moving mechanism 40 that changes the relative position between the detection mechanism 50 and the ultraviolet irradiation device 30 changes the relative position between the detection mechanism 50 that detects the irradiation level of the ultraviolet ray U, and the ultraviolet irradiation device 30 that includes the plurality of light emitting elements LD and that outputs the ultraviolet ray U. Accordingly, the irradiation control circuit 310 can adjust the intensity of the ultraviolet ray U at an optimal relative position between the detection mechanism 50 and the ultraviolet irradiation device 30 corresponding to the irradiance distribution of the ultraviolet ray U output by the ultraviolet irradiation device 30. That is, in the liquid ejecting apparatus 1 of the present embodiment, the intensity of the ultraviolet ray U can be optimally adjusted regardless of the irradiance distribution of the ultraviolet ray U. Accordingly, in the liquid ejecting apparatus 1 of the present embodiment, the ink contained in the dot Dw can be irradiated with the ultraviolet ray U having an optimal energy level. Thus, the probability of variation in the degrees of the curing and fixing of the ink is reduced, and the probability of a decrease in the quality of the image formed on the medium P is reduced.

In particular, when the ultraviolet irradiation device 30 that outputs the ultraviolet ray U includes the plurality of light emitting elements LD and outputs the ultraviolet ray U by emitting light via the plurality of light emitting elements LD, the irradiance distribution of the ultraviolet ray U output by the ultraviolet irradiation device 30 significantly changes for each liquid ejecting apparatus 1. Even in this case, in the liquid ejecting apparatus 1 of the present embodiment, the intensity of the ultraviolet ray U can be optimally adjusted regardless of the irradiance distribution of the ultraviolet ray U, and the ink contained in the dot Dw can be irradiated with the ultraviolet ray U having an optimal energy level. Thus, the probability of variation in the degrees of the curing and fixing of the ink is reduced, and the probability of a decrease in the quality of the image formed on the medium P is reduced. That is, even when the plurality of light emitting elements LD are used as a light source that performs irradiation with the ultraviolet ray U, the light quantity of the ultraviolet ray U with which the ink is irradiated can be appropriately controlled.

In the liquid ejecting apparatus 1 of the present embodiment, the irradiation control circuit 310 adjusts the intensity of the ultraviolet ray Ua in accordance with the irradiation level of the ultraviolet ray Ua detected by the detection mechanism 50 during the period in which the moving mechanism 40 changes the relative position between the detection mechanism 50 and the ultraviolet irradiation device 30a, and adjusts the intensity of the ultraviolet ray Ub in accordance with the irradiation level of the ultraviolet ray Ub detected by the detection mechanism 50 during the period in which the moving mechanism 40 changes the relative position between the detection mechanism 50 and the ultraviolet irradiation device 30b. Thus, even when the ultraviolet irradiation device 30a and the ultraviolet irradiation device 30b are included as the ultraviolet irradiation device 30, the irradiation control circuit 310 can optimally adjust the intensity of each of the ultraviolet rays Ua and Ub regardless of the irradiance distribution of each of the ultraviolet rays Ua and Ub. Accordingly, the ink contained in the dot Dw can be irradiated with the ultraviolet rays Ua and Ub having an optimal energy level. Thus, the probability of variation in the degrees of the curing and fixing of the ink is reduced, and the probability of a decrease in the quality of the image formed on the medium P is reduced.

In the method of controlling the liquid ejecting apparatus 1 of the present embodiment described above, the intensity adjustment process of adjusting the intensity of the ultraviolet ray U includes steps S2 and S5 in which the relative position between the detection mechanism 50 that detects the irradiation level of the ultraviolet ray U, and the ultraviolet irradiation device 30 that includes the plurality of light emitting elements LD and that outputs the ultraviolet ray U is changed, step S3 in which the irradiation level of the ultraviolet ray U is detected in synchronization with the change in the relative position in steps S2 and S5, and step S10 in which the intensity of the ultraviolet ray U is adjusted based on the irradiation level of the ultraviolet ray U detected in step S3. Thus, the intensity of the ultraviolet ray U can be adjusted at the optimal relative position between the detection mechanism 50 and the ultraviolet irradiation device 30 corresponding to the irradiance distribution of the ultraviolet ray U output by the ultraviolet irradiation device 30. That is, in the method of controlling the liquid ejecting apparatus 1 of the present embodiment, the intensity of the ultraviolet ray U can be optimally adjusted regardless of the irradiance distribution of the ultraviolet ray U. Accordingly, in the liquid ejecting apparatus 1 of the present embodiment, the ink contained in the dot Dw can be irradiated with the ultraviolet ray U having an optimal energy level. Thus, the probability of variation in the degrees of the curing and fixing of the ink is reduced, and the probability of a decrease in the quality of the image formed on the medium P is reduced.

In particular, when the ultraviolet irradiation device 30 that outputs the ultraviolet ray U includes the plurality of light emitting elements LD and outputs the ultraviolet ray U by emitting light via the plurality of light emitting elements LD, the irradiance distribution of the ultraviolet ray U output by the ultraviolet irradiation device 30 significantly changes for each liquid ejecting apparatus 1. Even in this case, in the method of controlling the liquid ejecting apparatus 1 of the present embodiment, the intensity of the ultraviolet ray U can be optimally adjusted regardless of the irradiance distribution of the ultraviolet ray U, and the ink contained in the dot Dw can be irradiated with the ultraviolet ray U having an optimal energy level. Thus, the probability of variation in the degrees of the curing and fixing of the ink is reduced, and the probability of a decrease in the quality of the image formed on the medium P is reduced. That is, even when the plurality of light emitting elements LD are used as a light source that performs irradiation with the ultraviolet ray U, the light quantity of the ultraviolet ray U with which the ink is irradiated can be appropriately controlled.

The method of controlling the liquid ejecting apparatus 1 of the present embodiment includes the step of adjusting the intensity of the ultraviolet ray Ua in accordance with the irradiation level of the ultraviolet ray Ua detected by the detection mechanism 50 during the period in which the relative position between the detection mechanism 50 and the ultraviolet irradiation device 30a is changed, and the step of adjusting the intensity of the ultraviolet ray Ub in accordance with the irradiation level of the ultraviolet ray Ub detected by the detection mechanism 50 during the period in which the relative position between the detection mechanism 50 and the ultraviolet irradiation device 30b is changed. Thus, even when the ultraviolet irradiation device 30a and the ultraviolet irradiation device 30b are included as the ultraviolet irradiation device 30, the intensity of each of the ultraviolet rays Ua and Ub can be optimally adjusted regardless of the irradiance distribution of each of the ultraviolet rays Ua and Ub. Accordingly, the ink contained in the dot Dw can be irradiated with the ultraviolet rays Ua and Ub having an optimal energy level. Thus, the probability of variation in the degrees of the curing and fixing of the ink is reduced, and the probability of a decrease in the quality of the image formed on the medium P is reduced.

### 4. Modification Example

In the liquid ejecting apparatus 1 of the present embodiment described above, the irradiation control circuit 310 adjusts the intensity of the ultraviolet ray U such that the maximum value of the irradiation level of the ultraviolet ray U, that is, the intensity or the light quantity of the ultraviolet ray U, detected by the detection mechanism 50 reaches the predetermined value during the period in which the moving mechanism 40 changes the relative position between the detection mechanism 50 and the ultraviolet irradiation device 30. Alternatively, the irradiation control circuit 310 may adjust the intensity of the ultraviolet ray U such that an integral value of the irradiation level of the ultraviolet ray U, that is the intensity or the light quantity of the ultraviolet ray U, detected by the detection mechanism 50 reaches a predetermined value during the period in which the moving mechanism 40 changes the relative position between the detection mechanism 50 and the ultraviolet irradiation device 30. That is, the irradiation control circuit 310 may adjust the intensity of the ultraviolet ray U such that the integral value of the irradiation level of the ultraviolet ray U detected in step S3 reaches the predetermined value.

Specifically, in step S8 shown in FIG. 7, the irradiation control circuit 310 may adjust the intensity designation signal Suv such that a sum of the light quantity, that is, the intensity, of the ultraviolet ray U included in each of the acquired intensity information Guv[1] to Guv[n] read from the storage circuit 340 reaches the predetermined value. Even in this case, the same action and effect as those of the above embodiment can be achieved.

The ultraviolet irradiation device 30 may include a mirror that condenses light output by the plurality of light emitting elements LD.

When the ultraviolet irradiation device 30 includes the mirror that condenses the light output by the plurality of light emitting elements LD, the ink contained in the dot Dw can be efficiently irradiated with the ultraviolet ray U output by the ultraviolet irradiation device 30, that is, the light output by the plurality of light emitting elements LD, and the ink contained in the dot Dw can be efficiently cured and fixed. However, the irradiance distribution of the ultraviolet ray U output by the ultraviolet irradiation device 30 significantly changes depending on an angle of the mirror, and the irradiance distribution is more complicated.

In the liquid ejecting apparatus 1 of the present embodiment, the intensity of the ultraviolet ray U can be optimally adjusted regardless of the irradiance distribution of the ultraviolet ray U. Thus, even when the ultraviolet irradiation device 30 includes the mirror that condenses the light output by the plurality of light emitting elements LD, the intensity of the ultraviolet ray U can be optimally adjusted, and the ink contained in the dot Dw can be irradiated with the ultraviolet ray U having an optimal energy level. Accordingly, the same action and effect as those of the above embodiment can be achieved.

In the liquid ejecting apparatus 1 of the present embodiment described above, the relative position between the detection mechanism 50 and the ultraviolet irradiation device 30a is changed by moving the carriage 70 on which the ultraviolet irradiation device 30a is mounted. Alternatively, the relative position between the detection mechanism 50 and the ultraviolet irradiation device 30a may be configured to be changed by moving the detection mechanism 50. Alternatively, the relative position between the detection mechanism 50 and the ultraviolet irradiation device 30a may be configured to be changed by moving both of the ultraviolet irradiation device 30a and the detection mechanism 50. The relative position between the detection mechanism 50 and the ultraviolet irradiation device 30a is not limited to being changed in the direction along the scanning axis and may be changed along the transport direction of the medium P or changed along an ejection direction in which the ink is ejected. Some of the change along the scanning axis, the change along the transport direction, and the change along the ejection direction may be configured to be combined with each other.

While the embodiments and the modification example are described above, the present disclosure is not limited to the embodiments and can be embodied in various aspects without departing from the concept of the present disclosure. For example, the embodiments can be combined with each other, as appropriate.

The present disclosure includes substantially the same configurations (for example, configurations having the same functions, methods, and results or configurations having the same objects and effects) as the configurations described in the embodiments. The present disclosure includes configurations obtained by replacing non-essential parts of the configurations described in the embodiments. The present disclosure includes configurations that achieve the same action and effects or configurations that can achieve the same objects as those of the configurations described in the embodiments. The present disclosure includes configurations obtained by adding a well-known technology to the configurations described in the embodiments.

The following contents are derived from the above embodiments.

According to an aspect, there is provided an ultraviolet-cured liquid ejecting apparatus including an ejection head that ejects a liquid cured by being irradiated with an ultraviolet ray, an ultraviolet light source that includes a plurality of light emitting elements and that outputs the ultraviolet ray, an intensity adjustment mechanism that adjusts intensity of the ultraviolet ray, an irradiation level sensor that detects an irradiation level of the ultraviolet ray, and a relative position control mechanism that changes a relative position between the irradiation level sensor and the ultraviolet light source, in which the intensity adjustment mechanism adjusts the intensity of the ultraviolet ray based on the irradiation level of the ultraviolet ray detected by the irradiation level sensor during a period in which the relative position control mechanism changes the relative position between the irradiation level sensor and the ultraviolet light source.

In the ultraviolet-cured liquid ejecting apparatus, the intensity adjustment mechanism that adjusts the intensity of the ultraviolet ray adjusts the intensity of the ultraviolet ray based on the irradiation level of the ultraviolet ray detected by the irradiation level sensor during a period in which the relative position control mechanism that changes the relative position between the irradiation level sensor and the ultraviolet light source changes the relative position between the irradiation level sensor that detects the irradiation level of the ultraviolet ray, and the ultraviolet light source that includes the plurality of light emitting elements and that outputs the ultraviolet ray. Accordingly, the intensity adjustment mechanism can adjust the intensity of the ultraviolet ray at an optimal relative position between the irradiation level sensor and the ultraviolet light source corresponding to an irradiance distribution of the ultraviolet ray output by the ultraviolet light source. That is, the intensity of the ultraviolet ray can be optimally adjusted regardless of the irradiance distribution of the ultraviolet ray. Accordingly, the liquid can be irradiated with the ultraviolet ray having an optimal energy level. Thus, a probability of variation in degrees of curing and fixing of the liquid is reduced, and a probability of a decrease in quality of an image formed on a medium is reduced.

In particular, when the ultraviolet light source that outputs ultraviolet ray includes the plurality of light emitting elements and outputs the ultraviolet ray by emitting light via the plurality of light emitting elements, the irradiance distribution of the ultraviolet ray output by the ultraviolet light source significantly changes for each ultraviolet-cured liquid ejecting apparatus. Even in this case, the intensity of the ultraviolet ray can be optimally adjusted regardless of the irradiance distribution of the ultraviolet ray, and the liquid can be irradiated with the ultraviolet ray having an optimal energy level. The probability of variation in the degrees of the curing and fixing of the liquid is reduced, and the probability of a decrease in the quality of the image formed on the medium is reduced. That is, even when the plurality of light emitting elements are used as a light source that performs irradiation with the ultraviolet ray, a light quantity of the ultraviolet ray with which the liquid is irradiated can be appropriately controlled.

In the ultraviolet-cured liquid ejecting apparatus according to the aspect, the ultraviolet light source may include a mirror that condenses the ultraviolet ray.

In the ultraviolet-cured liquid ejecting apparatus, when the ultraviolet light source includes the mirror, the irradiance distribution of the ultraviolet ray output by the ultraviolet light source is more complicated. However, the intensity of the ultraviolet ray can be optimally adjusted regardless of the irradiance distribution of the ultraviolet ray, and the liquid can be irradiated with the ultraviolet ray having an optimal energy level. The probability of variation in the degrees of the curing and fixing of the liquid is reduced, and the probability of a decrease in the quality of the image formed on the medium is reduced.

In the ultraviolet-cured liquid ejecting apparatus according to the aspect, the ultraviolet light source may include a first ultraviolet light source and a second ultraviolet light source, the first ultraviolet light source may include a plurality of first light emitting elements among the plurality of light emitting elements and outputs a first ultraviolet ray as the ultraviolet ray, the second ultraviolet light source may include a plurality of second light emitting elements among the plurality of light emitting elements and outputs a second ultraviolet ray as the ultraviolet ray, and the intensity adjustment mechanism may adjust intensity of the first ultraviolet ray in accordance with an irradiation level of the first ultraviolet ray detected by the irradiation level sensor during a period in which the relative position control mechanism changes a relative position between the irradiation level sensor and the first ultraviolet light source, and adjust intensity of the second ultraviolet ray in accordance with an irradiation level of the second ultraviolet ray detected by the irradiation level sensor during a period in which the relative position control mechanism changes a relative position between the irradiation level sensor and the second ultraviolet light source.

In the ultraviolet-cured liquid ejecting apparatus, the intensity adjustment mechanism adjusts the intensity of the first ultraviolet ray in accordance with the irradiation level of the first ultraviolet ray detected by the irradiation level sensor during the period in which the relative position control mechanism changes the relative position between the irradiation level sensor and the first ultraviolet light source, and adjusts the intensity of the second ultraviolet ray in accordance with the irradiation level of the second ultraviolet ray detected by the irradiation level sensor during the period in which the relative position control mechanism changes the relative position between the irradiation level sensor and the second ultraviolet light source. Thus, even when the first ultraviolet light source and the second ultraviolet light source are included as the ultraviolet light source, the intensity of each of the first ultraviolet ray and the second ultraviolet ray can be optimally adjusted regardless of an irradiance distribution of each of the first ultraviolet ray and the second ultraviolet ray. Accordingly, the liquid can be irradiated with the first ultraviolet ray and the second ultraviolet ray having an optimal energy level. Thus, the probability of variation in the degrees of the curing and fixing of the liquid is reduced, and the probability of a decrease in the quality of the image formed on the medium is reduced.

In the ultraviolet-cured liquid ejecting apparatus according to the aspect, the intensity adjustment mechanism may adjust the intensity of the ultraviolet ray such that a maximum value of the irradiation level of the ultraviolet ray detected by the irradiation level sensor reaches a predetermined value during the period in which the relative position control mechanism changes the relative position between the irradiation level sensor and the ultraviolet light source.

In the ultraviolet-cured liquid ejecting apparatus according to the aspect, the intensity adjustment mechanism may adjust the intensity of the ultraviolet ray such that an integral value of the irradiation level of the ultraviolet ray detected by the irradiation level sensor reaches a predetermined value during the period in which the relative position control mechanism changes the relative position between the irradiation level sensor and the ultraviolet light source.

According to another aspect, there is provided a method of controlling an ultraviolet-cured liquid ejecting apparatus that ejects a liquid cured by being irradiated with an ultraviolet ray, the method including a relative position control step of changing a relative position between an irradiation level sensor that detects an irradiation level of the ultraviolet ray, and an ultraviolet light source that includes a plurality of light emitting elements and that outputs the ultraviolet ray, a detection step of detecting the irradiation level of the ultraviolet ray in synchronization with the relative position control step, and an adjustment step of adjusting intensity of the ultraviolet ray based on the irradiation level of the ultraviolet ray detected in the detection step.

The method of controlling an ultraviolet-cured liquid ejecting apparatus includes the relative position control step of changing the relative position between the irradiation level sensor that detects the irradiation level of the ultraviolet ray, and the ultraviolet light source that includes the plurality of light emitting elements and that outputs the ultraviolet ray, the detection step of detecting the irradiation level of the ultraviolet ray in synchronization with the change in the relative position in the relative position control step, and the adjustment step of adjusting the intensity of the ultraviolet ray based on the irradiation level of the ultraviolet ray detected in the detection step. Thus, the intensity of the ultraviolet ray can be adjusted at an optimal relative position between the irradiation level sensor and the ultraviolet light source corresponding to an irradiance distribution of the ultraviolet ray output by the ultraviolet light source. That is, the intensity of the ultraviolet ray can be optimally adjusted regardless of the irradiance distribution of the ultraviolet ray. Accordingly, the liquid can be irradiated with the ultraviolet ray having an optimal energy level. A probability of variation in degrees of curing and fixing of the liquid is reduced, and a probability of a decrease in quality of an image formed on a medium is reduced.

In particular, when the ultraviolet light source that outputs the ultraviolet ray includes the plurality of light emitting elements and outputs the ultraviolet ray by emitting light via the plurality of light emitting elements, the irradiance distribution of the ultraviolet ray output by the ultraviolet light source significantly changes for each ultraviolet-cured liquid ejecting apparatus. However, in the method of controlling an ultraviolet-cured liquid ejecting apparatus, the intensity of the ultraviolet ray can be optimally adjusted regardless of the irradiance distribution of the ultraviolet ray, and the liquid can be irradiated with the ultraviolet ray having an optimal energy level. Thus, the probability of variation in the degrees of the curing and fixing of the liquid is reduced, and the probability of a decrease in the quality of the image formed on the medium is reduced. That is, even when the plurality of light emitting elements are used as a light source that performs irradiation with the ultraviolet ray, a light quantity of the ultraviolet ray with which the liquid is irradiated can be appropriately controlled.

In the method of controlling an ultraviolet-cured liquid ejecting apparatus according to the aspect, the ultraviolet light source may include a mirror that condenses the ultraviolet ray.

In the method of controlling an ultraviolet-cured liquid ejecting apparatus, when the ultraviolet light source includes the mirror, the irradiance distribution of the ultraviolet ray output by the ultraviolet light source is more complicated. However, the intensity of the ultraviolet ray can be optimally adjusted regardless of the irradiance distribution of the ultraviolet ray, and the liquid can be irradiated with the ultraviolet ray having an optimal energy level. The probability of variation in the degrees of the curing and fixing of the liquid is reduced, and the probability of a decrease in the quality of the image formed on the medium is reduced.

In the method of controlling an ultraviolet-cured liquid ejecting apparatus according to the aspect, the ultraviolet light source may include a first ultraviolet light source that includes a plurality of first light emitting elements among the plurality of light emitting elements and that outputs a first ultraviolet ray as the ultraviolet ray, and a second ultraviolet light source that includes a plurality of second light emitting elements among the plurality of light emitting elements and that outputs a second ultraviolet ray as the ultraviolet ray, the detection step may include a first detection step of detecting an irradiation level of the first ultraviolet ray in the relative position control step, and a second detection step of detecting an irradiation level of the second ultraviolet ray in the relative position control step, and the adjustment step may include a first adjustment step of adjusting intensity of the first ultraviolet ray based on the irradiation level of the first ultraviolet ray detected in the first detection step, and a second adjustment step of adjusting intensity of the second ultraviolet ray based on the irradiation level of the second ultraviolet ray detected in the second detection step.

In the method of controlling an ultraviolet-cured liquid ejecting apparatus, the detection step includes the first detection step of detecting the irradiation level of the first ultraviolet ray in the relative position control step and the second detection step of detecting the irradiation level of the second ultraviolet ray in the relative position control step, and the adjustment step includes the first adjustment step of adjusting the intensity of the first ultraviolet ray based on the irradiation level of the first ultraviolet ray detected in the first detection step and the second adjustment step of adjusting the intensity of the second ultraviolet ray based on the irradiation level of the second ultraviolet ray detected in the second detection step. Thus, even when the ultraviolet light source includes the first ultraviolet light source and the second ultraviolet light source, the intensity of each of the first ultraviolet ray and the second ultraviolet ray can be optimally adjusted regardless of the irradiance distribution of each of the first ultraviolet ray and the second ultraviolet ray. Accordingly, the liquid can be irradiated with the first ultraviolet ray and the second ultraviolet ray having an optimal energy level. Thus, the probability of variation in the degrees of the curing and fixing of the liquid is reduced, and the probability of a decrease in the quality of the image formed on the medium is reduced.

In the method of controlling an ultraviolet-cured liquid ejecting apparatus according to the aspect, in the adjustment step, the intensity of the ultraviolet ray may be adjusted such that a maximum value of the irradiation level of the ultraviolet ray detected in the detection step reaches a predetermined value.

In the method of controlling an ultraviolet-cured liquid ejecting apparatus according to the aspect, in the adjustment step, the intensity of the ultraviolet ray may be adjusted such that an integral value of the irradiation level of the ultraviolet ray detected in the detection step reaches a predetermined value.

What is claimed is:

1. An ultraviolet-cured liquid ejecting apparatus comprising:
an ejection head that ejects a liquid cured by being irradiated with an ultraviolet ray;
an ultraviolet light source that includes a plurality of light emitting elements and that outputs the ultraviolet ray;
an intensity adjustment mechanism that adjusts intensity of the ultraviolet ray;
an irradiation level sensor that detects an irradiation level of the ultraviolet ray; and
a relative position control mechanism that changes a relative position between the irradiation level sensor and the ultraviolet light source, wherein
the intensity adjustment mechanism adjusts the intensity of the ultraviolet ray based on the irradiation level of the ultraviolet ray detected by the irradiation level sensor during a period in which the relative position control mechanism changes the relative position between the irradiation level sensor and the ultraviolet light source.

2. The ultraviolet-cured liquid ejecting apparatus according to claim 1, wherein
the ultraviolet light source includes a mirror that condenses the ultraviolet ray.

3. The ultraviolet-cured liquid ejecting apparatus according to claim 1, wherein
the ultraviolet light source includes a first ultraviolet light source and a second ultraviolet light source,
the first ultraviolet light source includes a plurality of first light emitting elements among the plurality of light emitting elements and outputs a first ultraviolet ray as the ultraviolet ray,
the second ultraviolet light source includes a plurality of second light emitting elements among the plurality of light emitting elements and outputs a second ultraviolet ray as the ultraviolet ray, and
the intensity adjustment mechanism
adjusts intensity of the first ultraviolet ray in accordance with an irradiation level of the first ultraviolet ray detected by the irradiation level sensor during a period in which the relative position control mechanism changes a relative position between the irradiation level sensor and the first ultraviolet light source, and
adjusts intensity of the second ultraviolet ray in accordance with an irradiation level of the second ultraviolet ray detected by the irradiation level sensor during a period in which the relative position control mechanism changes a relative position between the irradiation level sensor and the second ultraviolet light source.

4. The ultraviolet-cured liquid ejecting apparatus according to claim 1, wherein
the intensity adjustment mechanism adjusts the intensity of the ultraviolet ray such that a maximum value of the irradiation level of the ultraviolet ray detected by the irradiation level sensor reaches a predetermined value during the period in which the relative position control mechanism changes the relative position between the irradiation level sensor and the ultraviolet light source.

5. The ultraviolet-cured liquid ejecting apparatus according to claim 1, wherein
the intensity adjustment mechanism adjusts the intensity of the ultraviolet ray such that an integral value of the irradiation level of the ultraviolet ray detected by the irradiation level sensor reaches a predetermined value during the period in which the relative position control mechanism changes the relative position between the irradiation level sensor and the ultraviolet light source.

6. A method of controlling an ultraviolet-cured liquid ejecting apparatus that ejects a liquid cured by being irradiated with an ultraviolet ray, the method comprising:
a relative position control step of changing a relative position between an irradiation level sensor that detects an irradiation level of the ultraviolet ray, and an ultraviolet light source that includes a plurality of light emitting elements and that outputs the ultraviolet ray;
a detection step of detecting the irradiation level of the ultraviolet ray in synchronization with the relative position control step; and
an adjustment step of adjusting intensity of the ultraviolet ray based on the irradiation level of the ultraviolet ray detected in the detection step.

7. The method of controlling an ultraviolet-cured liquid ejecting apparatus according to claim 6, wherein
the ultraviolet light source includes a mirror that condenses the ultraviolet ray.

8. The method of controlling an ultraviolet-cured liquid ejecting apparatus according to claim 6, wherein
the ultraviolet light source includes a first ultraviolet light source that includes a plurality of first light emitting elements among the plurality of light emitting elements and that outputs a first ultraviolet ray as the ultraviolet ray, and a second ultraviolet light source that includes a plurality of second light emitting elements among the plurality of light emitting elements and that outputs a second ultraviolet ray as the ultraviolet ray,
the detection step includes a first detection step of detecting an irradiation level of the first ultraviolet ray in the relative position control step, and a second detection step of detecting an irradiation level of the second ultraviolet ray in the relative position control step, and
the adjustment step includes a first adjustment step of adjusting intensity of the first ultraviolet ray based on the irradiation level of the first ultraviolet ray detected in the first detection step, and a second adjustment step of adjusting intensity of the second ultraviolet ray based on the irradiation level of the second ultraviolet ray detected in the second detection step.

9. The method of controlling an ultraviolet-cured liquid ejecting apparatus according to claim 6, wherein
in the adjustment step, the intensity of the ultraviolet ray is adjusted such that a maximum value of the irradiation level of the ultraviolet ray detected in the detection step reaches a predetermined value.

10. The method of controlling an ultraviolet-cured liquid ejecting apparatus according to claim 6, wherein
in the adjustment step, the intensity of the ultraviolet ray is adjusted such that an integral value of the irradiation level of the ultraviolet ray detected in the detection step reaches a predetermined value.
